(19) United States
(12) Patent Application Publication
(10) Pub. No.: US 2016/0191594 A1
(43) Pub. Date: Jun. 30, 2016

(54) CONTEXT AWARE STREAMING MEDIA TECHNOLOGIES, DEVICES, SYSTEMS, AND METHODS UTILIZING THE SAME

(71) Applicant: Intel Corporation, Santa Clara, CA (US)

(72) Inventors: Hassnaa Moustafa, Portland, OR (US); Kedar A. Dongre, Hillsboro (CA); William J. Lewis, North Plains, OR (US)

(21) Appl. No.: 14/582,942

(22) Filed: Dec. 24, 2014

(51) Int. Cl. H04L 29/06; H04L 29/08

(52) U.S. Cl. CPC H04L 65/604; H04L 67/327; H04L 67/42

(57) ABSTRACT

Technologies for performing contextually adaptive media streaming are described. In some embodiments, the technologies utilize contextual parameters leverage contextual information to alter the parameters of a content stream that is provided to a client device from a server. In some embodiments, the parameters of the content stream are altered by changing one or more input parameters (e.g., a report of network parameters) that is/are operated on by adaptive logic of a media player on the client device. Alternatively or additionally, in some embodiments the technologies leverage contextual information to alter the manner in which a client device processes content in a received content stream for consumption. Systems, devices, and methods employing the technologies are also described.

### FIELD

The present disclosure generally relates to context aware media streaming technologies. Devices, systems and methods utilizing such technologies are also described.

### BACKGROUND

In recent years, the distribution and consumption of multimedia (e.g., audiovisual) content over the internet and other distribution networks has increased dramatically. Indeed, it is now commonplace for consumers to utilize myriad electronic devices to access and consume high quality content such as music, television shows, movies, radio broadcasts, etc., which may be transmitted to the consumer's device via wired or wireless communication.

Interest has particularly grown in the use of media streaming technologies to deliver content to electronic devices for consumption. In many instances such technologies leverage a client server architecture, wherein the client includes a media player through which a user may select content that is available on a server for streaming. In response to the selection the client may send a request to the server for the selected content. In response, the server may begin transmitting content data associated of the selected content to the client.

As the content data is received, it may be buffered in one or more buffers (e.g. of the media player). Once the buffer is full or contains a threshold amount of content data, at least a portion of the content data in the buffer may be processed for display. As content data in the buffer is decoded and/or displayed it may be discarded and replaced with new content data received from the server. In this way, the consumer may view the selected content without having to wait for his device to download all of content data associated with the selected content.

Early media streaming technologies often presented a frustrating user experience, particularly in instances where a network connection between the user's device (client) and the server was relatively poor. In such instances content data in the buffer(s) used by the media player was often processed for consumption faster than it could be replaced with new content data from the server. Under such conditions the media player buffer(s) may starve, forcing the client to pause playback of the selected content until a sufficient amount of content data was received from the server and buffered. This issue is particularly problematic in instances where a user or the media player requests the server to provide content at a level of quality that exceeds the capabilities of the network connection between the client device and server.

Adaptive streaming technologies have been developed to address the above mentioned problem. In many instances, such technologies utilize a client that includes a media player that employs adaptive logic to adjust the quality of a content stream based on monitored buffer level(s) and the bandwidth of the network connection between the client and server. For example, consider a scenario in which a client requests a server to provide a relatively high quality content stream, but where the bandwidth of the network connection and the server is relatively small. In such instances the adaptive logic may determine that buffer starvation may occur and may cause the media player to request that the server downgrade the quality of the content stream (e.g., to request a lower bit rate stream), so as to maintain uninterrupted playback of the content on the client device (albeit at reduced quality).

Although existing adaptive streaming technologies are useful, they are understood to mostly rely on network bandwidth status reflected by buffer levels to drive the selection of the stream quality (reflected by the video compression bit-rate). As a result, such technologies may not provide an optimal user experience, which may be impacted by other contextual parameters. Moreover, existing adaptive streaming technologies are not understood to utilize contextual parameters to adjust the manner in which a content stream is processed by the client device for consumption.

### BRIEF DESCRIPTION OF THE DRAWINGS

FIG. 1 is a high level diagram of a client-server architecture.

FIG. 2 is a block diagram of an adaptive streaming system.

FIG. 3 is a block diagram of an adaptive streaming system consistent with the present disclosure.

FIG. 4 is a flow chart of example operations of an adaptive streaming method consistent with the present disclosure.

FIG. 5 illustrates a messaging flow in accordance with one example of an adaptive streaming method consistent with the present disclosure

FIG. 6 illustrates a messaging flow in accordance with another example of an adaptive streaming method consistent with the present disclosure.

### DETAILED DESCRIPTION

While the present disclosure is described herein with reference to illustrative embodiments for particular applications, it should be understood that such embodiments are exemplary only and that the invention as defined by the appended claims is not limited thereto. Indeed for the sake of illustration the technologies described herein may be discussed in the context of one or more use models in which one or more hand gestures are recognized. Such discussions are exemplary only, and it should be understood that all or a portion of the technologies described herein may be used in other contexts and with other gestures. Those skilled in the relevant art(s) with access to the teachings provided herein will recognize additional modifications, applications, and embodiments within the scope of this disclosure, and additional fields in which embodiments of the present disclosure would be of utility.

The technologies described herein may be implemented using one or more devices, e.g., in a client-server architecture. The terms “device,” “devices,” “electronic device” and “electronic devices” are interchangeably used herein to refer individually or collectively to any of the large number of electronic devices that may be used as a client and/or a server consistent with the present disclosure. Non-limiting examples of devices that may be used in accordance with the present disclosure include any kind of mobile device and/or non-mobile device, such as cameras, cell phones, computer terminals, desktop computers, electronic readers, facsimile machines, kiosks, netbook computers, notebook computers, internet devices, payment terminals, personal digital assistants, media players and/or recorders, servers, set-top boxes, smart phones, tablet personal computers, ultra-mobile personal computers, wired telephones, combinations thereof, and the like. Such devices may be portable or stationary. Without limitation, the devices described herein are preferably in the form of one or more cell phones, desktop computers, laptop computers, smart phones and tablet personal computers.

The terms “client” and “client device” are interchangeably used herein to refer to one or more electronic devices that may perform client functions consistent with the present disclosure. In general, the terms “client” and “client device” are used herein to refer to devices that receive and process streamed content from a server. In contrast, the terms “server,” “server device,” and “media server” are interchangeably used herein to refer to one or more electronic devices that may perform server functions consistent with the present disclosure. More specifically, such terms refer to one or more electronic devices that may transfer content to one or more client devices via wired or wireless communication, e.g. in accordance with one or more media streaming protocols.

It is noted that for ease of understanding the specification describes and the FIGS. illustrate example system and method embodiments in accordance with the present disclosure as including or being performed with a single client and a single server. Such illustrations are for the sake of example and it should be understood that any number of clients and servers may be used. Indeed, the technology described herein may be implemented with a plurality (e.g., 2, 5, 10, 20, 50, 100 or more) of client and/or server devices. Thus, while the present disclosure may refer to a client and/or a server in the singular, such expressions should be interpreted as also encompassing the plural form. Similarly, the designation of a device as a client or server is for clarity, and it should be understood that client devices may be configured to perform server functions, and that server devices may be configured to perform client functions consistent with the present disclosure.

The terms “content” and “media” are interchangeably used herein to refer to digital information such as audio, video, imagery, text, markup, software, combinations thereof, and the like, which may be stored in digital form (e.g., as content data) on a computer readable medium.

As used in any embodiment herein, the term “module” may refer to software, firmware, circuitry, or combinations thereof, which are configured to perform one or more operations consistent with the present disclosure. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, software and/or firmware that stores instructions executed by programmable circuitry. The modules described herein may, collectively or individually, be embodied as circuitry that forms a part of one or more devices, as defined previously. Likewise in some embodiments the modules described herein may be in the form of logic that is implemented at least in part in hardware to perform one or more operations consistent with the present disclosure.

The phrase “close range communication” is used herein to refer to technologies for sending/receiving data signals between devices that are relatively close to one another, i.e., via close range communication. Close range communication includes, for example, communication between devices using a BLUETOOTH™ network, a personal area network (PAN), near field communication, a ZigBee network, a wired Ethernet connection, combinations thereof, and the like. In contrast, the phrase “long range communication” is used herein to refer to technologies for sending/receiving data signals between devices that are a significant distance away from one another, i.e., using long range communication. Long range communication includes, for example, communication between devices using a WiFi network, a wide area network (WAN) (including but not limited to a cell phone network (3G, 4G, etc. and the like), the internet, telephony networks, combinations thereof, and the like.

In general, the present disclosure relates to technologies on a client platform that leverage contextual information to alter the quality or other characteristics of a content stream that is provided from a server to a client. Alternatively or additionally, the technologies described herein in some embodiments utilize contextual information to alter the manner in which a received content stream is processed by a client device for consumption, e.g., for display. More particularly and as will be described in detail below, in some embodiments the technologies described herein use contextual information to set or otherwise determine parameters of a content stream (hereinafter, “stream parameters”) that is or is to be provided from a server to a client. Alternatively or additionally, in some embodiments the technologies described herein use contextual information to set or otherwise determine one or more graphics parameters that specify how a received content stream is to be processed, e.g., by a graphics pipeline of the client. In this way, the technologies described herein enable context sensitive media applications that can make use of a wide variety of contextual information (e.g., of one or more sensors) to enhance user experience.

Before discussing aspects of the present disclosure in detail, it may be helpful to understand the operation of certain adaptive streaming technologies that do not rely on contextual information and/or triggers from a client platform to drive a determination on how parameters of a content stream are adapted, and/or whether a received content stream is to be processed in a particular manner. The present disclosure will therefore initially describe the operation of some examples of adaptive streaming technologies that do not leverage contextual information and/or platform trigger(s). Various aspects of the present disclosure will be described thereafter.

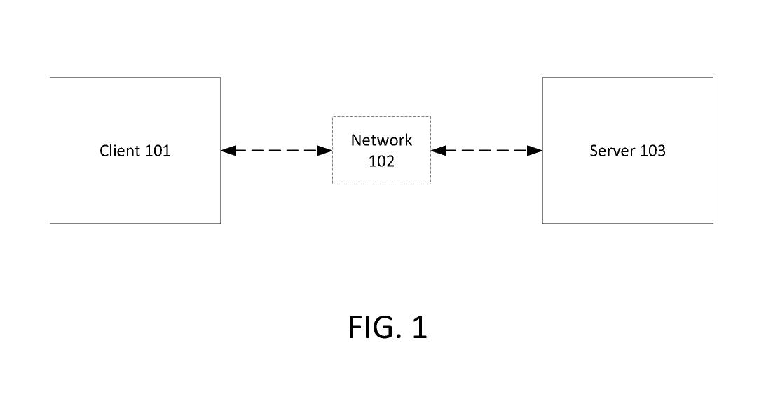

FIG. 1 depicts one example of a client-server model that may be used to support content streaming. As shown, system 100 includes client 101 and server 103, which may be communicatively coupled to one another directly or through optional network 102. Client 101 and server 103 may be any suitable device, such as the client and server devices noted above. Network 102 may be any suitable wired or wireless communications network, which may be configured to enable such wired or wireless communication between client 101 and server 103 via short range communication, long range communication, or a combination thereof.

In general, a user of client 101 may wish to consume content that is stored on server 103, e.g. in the form of one or more digital media files. In this regard, server 103 may be configured to stream (e.g., via network 102) content stored thereon to client 101. In turn, client 101 may be configured to process an incoming (received) content stream for consumption, e.g., on a display thereof. Of course many variations of the system of FIG. 1 are possible, and it should be understood that the illustrated system is for the sake of example only. For example, the present disclosure envisions embodiments in which client 101 does not communicate directly with server 103.

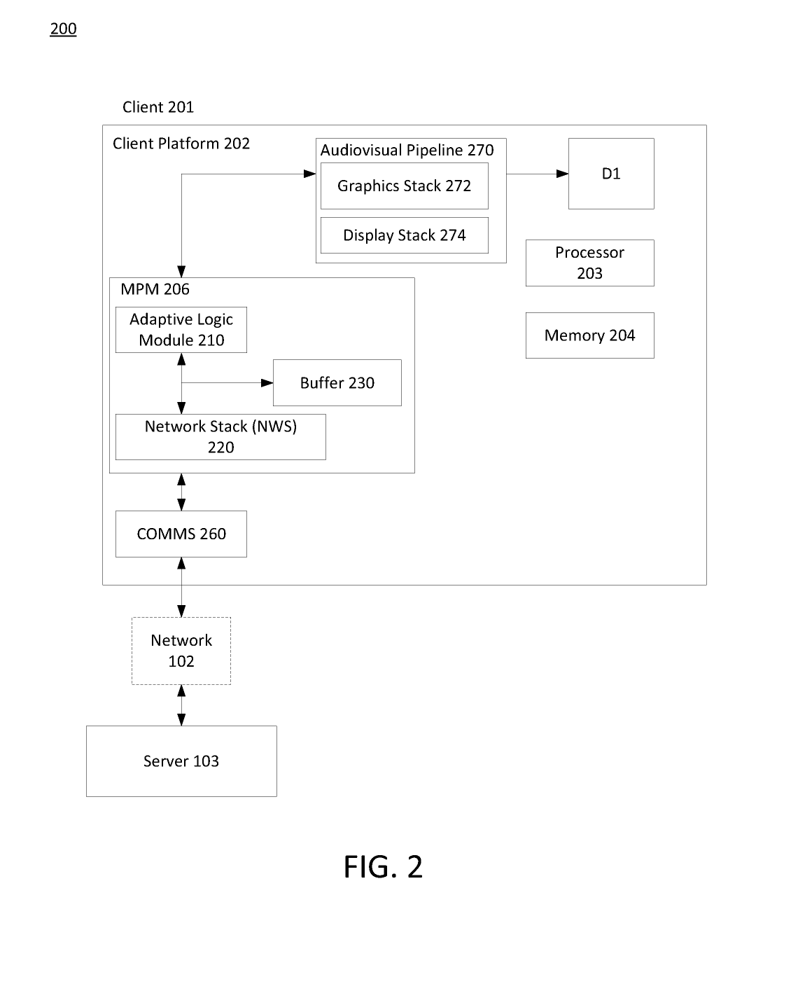

Reference is now made to FIG. 2, which is a block diagram of one example of an adaptive streaming system that does not leverage contextual information. As shown, system 200 includes client 201 (corresponding to client 101 of FIG. 1), optional network 102, and server 103. Client 201 includes device platform 202, which may be any suitable device platform. In some embodiments device platform 202 correlates to the type of electronic device used as client device 201. Thus for example where client device 201 is in the form of a cellular phone, a smart phone, a security terminal, or a desktop computer, device platform 202 may be a cellular phone platform, a smart phone platform, a security terminal platform, or a desktop computer platform, respectively.

As further shown, device platform 202 includes processor 203, memory 204, a media player module (MPM) 206, communications interface (COMMS) 260, audiovisual pipeline 270, and a display (D1). Such components may communicate with one another via a transport layer interface (not labeled), such as one or more physical buses, point to point connections, interconnects, etc., which may be connected by appropriate bridges, adapters, or controllers. It is noted that for the sake of illustration, display D1 is shown as integral with device platform 202. It should be understood that this is for the sake of example only, and that display D1 may be separate from device platform 202.

Processor 203 may be any suitable processor, including but not limited to one or more central processing units (CPUs), graphical processing units (GPUs), and application specific integrated circuits that can execute software or firmware stored in memory 204. Accordingly, processor 203 may include one or more programmable general-purpose or special-purpose microprocessors, digital signal processors (DSPs), programmable, application specific integrated circuits (ASICs), programmable logic devices (PLDs), or the like, or a combination of such devices.

Memory 204 may be any suitable memory, such as but not limited to random access memory (RAM), read-only memory (ROM), flash memory, magnetic memory, resistive memory, magneto-optical memory, or a combination of such memories. In some embodiments memory 204 may contain, among other things, computer readable instructions which when executed by processor 203, causes client device 201 to perform operations to implement content streaming operations, either alone or in combination with server 103.

COMMS 260 is generally configured to enable communication between client device 201 and server 103, either directly or via network 102. In this regard, COMMS 260 may be configured to enable communication using one or more predetermined wired or wireless communications protocol, such as but not limited to an Internet Protocol, WI-FI protocol, BLUETOOTH protocol, combinations thereof, and the like. COMMS 260 may therefore include hardware (i.e., circuitry), software, or a combination of hardware and software that allows client device 201 to send and receive data signals to/from server 103. COMMS 260 may therefore include one or more transponders, antennas, BLUETOOTH® chips, personal area network chips, near field communication chips, Wi-Fi chips, cellular antennas, combinations thereof, and the like.

MPM 206 generally functions to facilitate and manage the streaming of content from server 103 to client 201. Thus for example, in some embodiments MPM 206 may include, be in the form of, or be configured to execute an adaptive media streaming player, such as a hypertext markup language (HTML) or native adaptive media streaming player. Non-limiting examples of suitable media players include public and private media streaming players, such as the YOUTUBE® media player, NETFLIX® player, the MICROSOFT″® SILVERLIGHT® player, ADOBE® FLASH® player, APPLE® QUICKTIME® and the like. Regardless of the media player employed by MPM 206, in some embodiments MPM 206 or another component of client 201 may include a graphical user interface through which a user may identify and select content on server 103 for streaming.

Among other things, media player module (MPM) 206 may be configured to implement one or more adaptive streaming protocols, such as but not limited to dynamic adaptive streaming over HTTP (DASH), HTTP (hypertext transfer protocol) live streaming (HLS), Smooth Streaming, combinations thereof, and the like. In any case, MPM 206 may be configured to support the reception and display of content which may be streamed from server 103 to client 201 at variety of bit rates, i.e., where the content is encoded in segments (e.g., packets or another suitable form) and at a variety of different bit rates that cover relatively short aligned intervals of play back time. As a segment of content is played, MPM 206 may dynamically selects the bit-rate of the content in the next segment to be downloaded and played based at least in part on network conditions (i.e., parameters of the network, connection between client 101 and server 103). In some instances, MPM 206 may be configured to select the next segment with the highest bit-rate possible that can be downloaded in time for playback without causing playback artifacts (e.g., hitches, pauses) or the need for re-buffering.

In response to the selection of content, MPM 206 or another component may cause client device 201 to transmit a content request message to server 103. The content request message may include a content identifier (e.g., specifying the content to be streamed), as well as one or more streaming parameters. Without limitation, in some embodiments the streaming parameter(s) included in the content request message specify or otherwise control the quality of the content stream that is to be provided by server 103, and/or the bit-rate of the content provided therein.

For example, MPM 206 may cause client 201 to transmit a content request that includes one or more streaming parameters that cause server 103 to stream content to client 201 at a certain quality level (e.g., at a certain bit rate, where higher bit rate generally correlates to higher quality content). In some embodiments the quality level may be associated with a video resolution (e.g., 480p, 720p, 1080p, etc.), a level of audio quality, combinations thereof, and the like. In any case, the quality level of the content and/or stream may be initially set by one or more streaming parameters in MPM 206, e.g., in response to a user selection or in accordance with predetermined quality parameters (e.g., as may be specified by the manufacturer or MPM 206).

Of course the use of streaming parameters that specify the quality of a content stream and/or the content therein is enumerated for the sake of example only, and other streaming parameters may be included in the media request message sent by client 201. Indeed, the present disclosure envisions embodiments wherein a content request message includes streaming parameters that specify content resolution, frame per second, or other parameters. In any case, the content request message may cause server 103 to transmit a content stream to client 201, e.g., in accordance with the streaming parameters included in the content request message, as well as one or more predetermined media streaming protocols.

As further shown in FIG. 2, MPM 206 includes adaptive logic module 210, network stack (NWS) 220, and buffer 230, which may communicate with one another via a bus (not labeled) or another suitable transport medium. A content stream may be initiated by transmitting a first content request message from client 201 to server 103, as explained previously. Consistent with that discussion the first content request message may include a content identifier and first stream parameters, which may specify the quality and/or other characteristics of a content stream that is to be provided by server 103.

In response to the first content request message, server 103 may begin to transmit segments of content to client 201, e.g., via network 102 and in accordance with the first stream parameters (e.g., at an initial quality/bit rate set by the first stream parameters). The content segments may be received via COMMS 260 and transferred (e.g., via network stack 220) to buffer 230. When buffer 230 is full or reaches a threshold capacity, one or more segments of the content in buffer 230 may be transferred from MPM 206 to other components of client 101 for consumption. In the illustrated example the content stream provided by server 103 includes a graphical component, and therefore FIG. 2 illustrates that segments of content in buffer 230 are transferred to audiovisual pipeline 270 for consumption.

Audiovisual pipeline 270 includes graphics stack 272 and display stack 274, either of which may perform (or cause the performance of) one or more processing operations on the content segment(s). For example, graphics stack 272 may perform or cause the performance of one or more encoding operations, decoding operations, transcoding operations, post-processing operations (e.g., color enhancement, contrast enhancement, edge enhancement, anti-aliasing, etc.) combinations thereof, and the like, on one or more content segments of a received content stream. Upon completion of such operations (or if such operations are not required), the processed content segment(s) may be transferred to display stack 274, which may render the processed content segments for consumption, e.g. on display D1. In addition to graphics stack 272 and display stack 274, audiovisual pipeline 270 may include an audio stack (not shown), which may be responsible for processing audio information in a received content stream for consumption.

As content is streamed from server 103 to client 201, adaptive logic module 210 may monitor the capacity of buffer 230 and the conditions of the network connection (also referred to herein as an “actual network connection”) between client 201 and server 103. For example, adaptive logic module 210 may inspect the status of buffer 230 (e.g., using a query message) to determine its capacity at any point in the streaming process. Alternatively or additionally, adaptive logic module 210 may issue a query message to NWS 220. The query message may be configured to cause NWS 220 to report various conditions of the actual network connection between client 201 and server 103 to adaptive logic module 210. Non-limiting examples of network conditions that may be reported by NWS 220 in response to a query from MPM 206 include the latency of the connection between client 201 and server 103, the bandwidth of that connection, the number of packets dropped, combinations thereof, and the like.

Based on network conditions reported by NWS 220 and the status of buffer 230, the adaptive logic module 210 may determine that an adjustment to the content stream provided by server 103 may be of interest. For example, in some instances adaptive logic module 210 may determine, based on network conditions reported by NWS 220, that buffer 230 may starve (e.g., lack sufficient content data to maintain playback) if the content stream is maintained at the current bit-rate. In such instances, adaptive logic module 210 may cause client 201 to transmit a second content request message to server 103. The second content request message may specify second stream parameters that differ from the first stream parameters, and which may be designed to maintain uninterrupted playback of the content stream on client 201. For example, the second stream parameters may specify the transmission of a lower quality stream/content (e.g., the transmission of lower bit rate content) to client 201, so as to prevent starvation of buffer 230, or at least extend the amount of time that will pass before buffer 230 will starve.

Alternatively, where buffer 230 is consistently full and the network conditions reported by NWS 220 indicated that the connection between client 201 and server 103 is strong (e.g., high bandwidth, low latency, etc.), adaptive logic module 210 may determine that a higher quality content stream may be supported. In such instances and like the prior case, adaptive logic module 210 may cause client 201 to transmit a second content request message to server 103, but in this case the second content request may include stream parameters that cause server 103 to transmit a higher quality content stream (e.g., containing higher bit rate content) to client 101.

Thus, adaptive streaming systems such as the one shown in FIG. 2 and described above use actual network and/or buffer conditions to adjust the quality or other characteristics of a content stream, so as to provide uninterrupted content playback. Although such systems are useful, they do not take into account various contextual factors which may impact the experience of a user consuming the content. For example, the adaptive logic of such systems does not take into account user context factors, environment context factors, device context factors, combinations thereof, and the like, any or all of which may have a significant impact on user experience. Rather, adjustments to the content stream are based solely on buffer status, actual network conditions/parameters, or a combination thereof. In addition, adjustments to the content stream may be managed by software executing on the client, without consideration for contextual information and/or triggers from the client device platform that can be leveraged to adjust user experience.

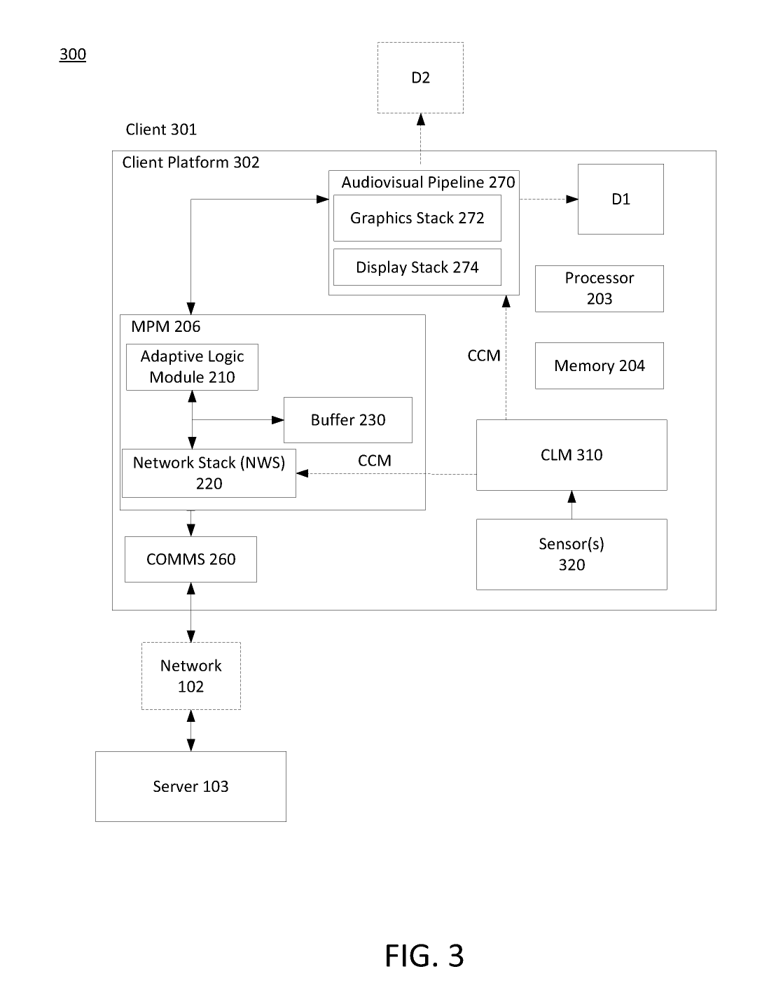

With the foregoing in mind one aspect of the present disclosure relates to a context aware media streaming system that is controlled by the client device platform and, more particularly, to context aware client devices in such a system. In this regard reference is made to FIG. 3, which is a block diagram of one example of a context aware media streaming system consistent with the present disclosure. As shown, system 300 includes client 301 and server 103, which may communicate with one another directly or through optional network 102. Without limitation, in some embodiments client 301 and server 103 are configured to communicate with one another via wired or wireless communication, and in accordance with one or more predetermined communications protocols. The nature and functions of server 103 and optional network 102 are described above in connection with FIGS. 1 and 2, and so are not reiterated for the sake of brevity.

As further shown in FIG. 3, client 301 includes client platform 302 which, like client platform 202, may be any suitable platform. In some embodiments device platform 302 correlates to the type of electronic device used as client device 301. Thus for example where client device 301 is in the form of a cellular phone, a smart phone, a security terminal, or a desktop computer, device platform 302 may be a cellular phone platform, a smart phone platform, a security terminal platform, or a desktop computer platform, respectively.

Client platform 302 also includes processor 203, memory 204, a media player module (MPM) 206, communications interface (COMMS) 260, audiovisual pipeline 270, and a display (D1). The nature and operation of processor 203, memory 204, and COMMS 260 are the same as previously described in connection with FIG. 2. A detailed description of such components is therefore not reiterated in the interest of brevity.

In addition to the foregoing components, client platform 302 includes context logic module (CLM) 310, which may be in wired or wireless communication with one or more sensor(s) 320. As will be described in detail below, CLM 310 is generally configured to analyze context information, correlate such context information to a desired user experience, and to transmit context control messages. In general, the context control messages may be configured to alter the content stream provided by server 103, and/or the manner in which content is processed by client 301 for consumption, e.g., by audiovisual pipeline 270. In this way, CLM 310 may leverage contextual information to alter streaming content reception and/or consumption, e.g., to attain a desired user experience.

The type of contextual information that may be utilized by CLM 310 is not limited, and any suitable contextual information may be used. Non-limiting examples of suitable contextual information include user context, device context, and environment context factors. Some non-limiting examples of suitable user context factors include user identity, user/device location, user activity (moving, sitting, walking, running, etc.), screen focus (i.e., region of a display focused on by a user), user preferences (e.g. as specified in one or more user profiles) etc., combinations thereof, and the like. Some non-limiting examples of suitable environment context factors include ambient noise level, ambient light level, device location, security level, combinations thereof, and the like. Non-limiting examples of suitable device context factors include screen size, display resolution, use of multiple displays, use of an external display, battery level, application status, processor workload, combinations thereof, and the like. Network context (e.g., latency, bandwidth, packet loss, etc.) may also be utilized by CLM 310.

CLM 310 may obtain and/or derive contextual information from any suitable source, such as but not limited to data provided or otherwise obtained from sensor(s) 320. In this regard sensor(s) 320 may include or be in the form of one or more physical or virtual sensors. Non-limiting examples of suitable physical sensors include accelerometers, gyrometers, magnetometers, audio/noise sensors (e.g., microphones), pressure sensors, temperature sensors, ambient light sensors, infrared proximity sensors, wireless devices (BLUETOOTH®, near field communication, Wi-Fi, global positioning sensors, two dimensional and three dimensional (e.g., depth) cameras, touch screens, biometric readers, combinations thereof, and the like. Non-limiting examples of suitable virtual sensors include processor workload sensors, battery life sensors, network status sensors, memory usage sensors, wireless connection status sensors, application status sensors, combinations thereof, and the like.

Alternatively or in addition to sensor(s) 320, CLM 310 may obtain or derive contextual information from other sources, such as but not limited to data stored in memory 204. For example, memory 204 may store a user profile associated with a user of client 301. In such instances the user profile may contain contextual information that may be of use to CLM 310, e.g., in the determination of a desired user experience and/or in the generation of one or more context control messages. For example, in some embodiments the user profile may contain user context such as user identity, user preferences, user security level, user settings, etc., any or all of which may be leveraged by CLM 310 as discussed below. Of course, other context (e.g., device and environment context as noted above) may also be included in a user profile. Alternatively or in addition to a user profile, other data, applications, etc. stored in memory 204 may provide contextual information to CLM 310 that may be useful in the generation of a context control message. Of course, CLM 310 may also obtain useful contextual information from other sources, such as but not limited to user inputs, communications from one or more remote devices (e.g., server 103 or a third party device), combinations thereof, and the like.

As noted above, CLM 310 may collect or otherwise obtain contextual information from a variety of sources. As or once contextual information is acquired, CLM 310 may analyze the contextual information to determine contextual streaming and/or contextual consumption parameters that may be used to affect the manner in which content is streamed to client 301, and/or the manner in which content in a received content stream is processed for consumption by client 301.

As used herein, the term “streaming parameters” refers to characteristics of a content stream and/or the content transmitted therein. Non-limiting examples of streaming parameters include the bit rate of the content in question, the resolution of the content, the frames per second of the content, combinations thereof, and the like. Contextual streaming parameters are streaming parameters that are determined (e.g., by adaptive logic module 210 or CLM 310) based at least in part on contextual information.

In some embodiments and as will be described below, contextual streaming parameters may be set or otherwise determined based at least in part on contextual network parameters, which may be understood as synthetic or artificial network parameters that are determined (e.g., by CLM 310) based at least in part on contextual information. In contrast, “actual network parameters” may be understood to refer to network parameters of an actual network connection between a client and server, e.g., client 301 and server 103.

It is further noted that the term “consumption parameters” is used herein to refer to parameters that affect how a client device processes content received in a content stream for consumption. Non-limiting examples of consumption parameters include various graphics and audio processing parameters/operations such as contrast enhancement, color enhancement, brightness enhancement, edge enhancement, anti-aliasing, audio enhancement, media decoding, media encoding, media transcoding, combinations thereof, and the like. Other non-limiting examples of consumption parameters include display parameters, such as rendering parameters, scaling/resolution parameters, combinations thereof, and the like. “Contextual consumption parameters” are consumption parameters that are determined (e.g., by CLM 301) based at least in part on contextual information.

As noted previously, CLM 310 may function at least in part to determine contextual network, contextual streaming and/or contextual consumption parameters that may be used to attain a desired user experience. In this context, user experience refers to the experience a user may have with regard to the reception and/or consumption of a content stream on a client device. Thus for example, CLM 310 may use contextual factors to identify contextual network parameters that may be used (e.g., by adaptive logic module 210) to determine contextual streaming parameters, which may in turn be used to adjust the characteristics of a content stream or content therein (e.g., bit-rate, resolution, and the like). Alternatively or additionally, CLM 310 may use contextual factors to identify contextual consumption factors that may be used to control the manner in which the audiovisual pipeline of a client device processes content in a received content stream, e.g., for consumption by a user. In any case, CLM 310 may determine contextual network, contextual streaming, and/or contextual consumption parameters using one or more of machine learning algorithms, heuristics, user preferences, lookup tables, combinations thereof, and the like.

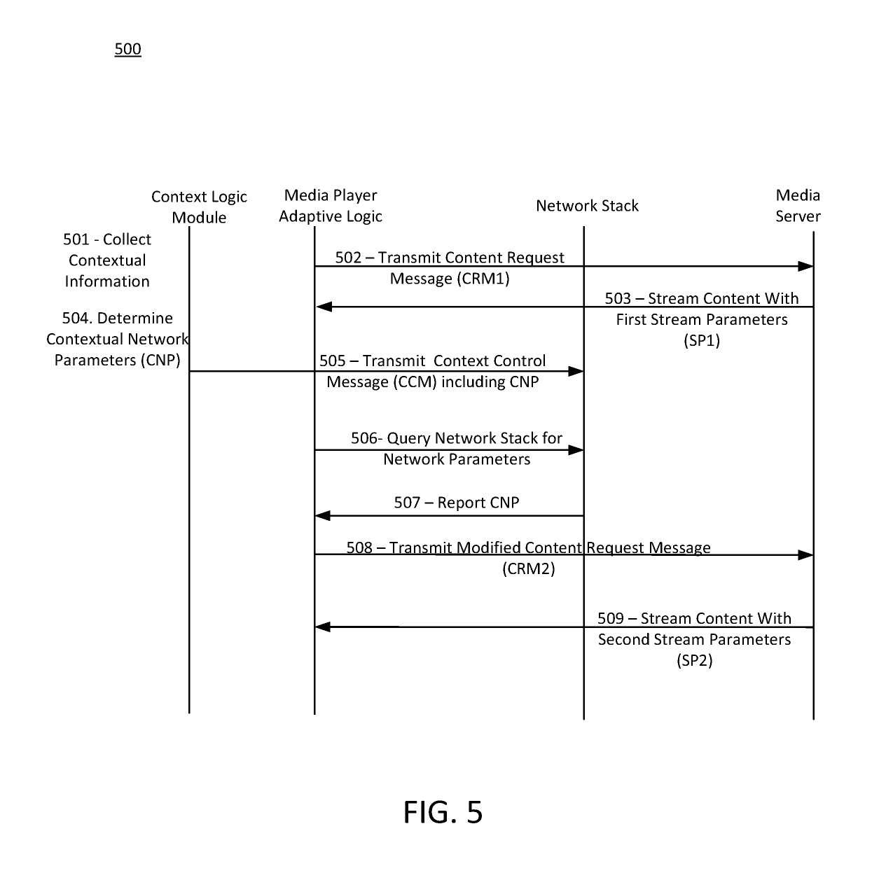

With the foregoing in mind, in some embodiments CLM 310 may be configured to alter one or more of the inputs utilized by adaptive logic module 210, based at least in part on contextual information. In some embodiments, the altered input is the network conditions reported by network stack 220 to adaptive logic module 210, e.g., in accordance with the normal operation of media player module 206. More specifically, CLM 310 may formulate a context control message including contextual network parameters, and transmit the context control message to network stack 220, as shown in FIG. 3 and later described in FIG. 5. The context control message may be configured to cause network stack 220 to report the contextual network parameters to adaptive logic module 210, e.g., in response to a query.

As may be appreciated, the contextual network parameters may differ from the parameters of an actual network connection between client 101 and server 103 (i.e., actual network parameters). Adaptive logic module 210 may therefore perform its functions based at least in part on the altered input (e.g., the contextual network parameters), which may result in the issuance of a media request message including contextual streaming parameters. As may also be appreciated, the contextual streaming parameters (e.g., bit-rate) determined by adaptive logic module 210 based on the contextual network parameters may be different from the streaming parameters that adaptive logic module 210 would have determined from parameters of the actual network connection between client 301 and server 103.

In some embodiments, the contextual network parameters (e.g., latency, packet drop, bandwidth, etc.) determined by CLM 310 may be set or otherwise determined at least in part by contextual factors such as those noted above. For example in some embodiments CLM 310 may determine contextual network parameters based on one or more of the battery life of client 101, the resolution of the output display (e.g., displays D1 and/or D2), user preference information, user location, motion information, environmental context, combinations thereof, and the like. In any case, the contextual network parameters may be designed to cause adaptive logic to adjust the streaming parameters (e.g., bit-rate) of a content stream in a manner supportive of a desired user experience.

For example where CLM 310 determines that contextual information suggests a strong preference for high resolution content (e.g. high resolution display, multi display rendering, etc.), it may cause the contextual network parameters to be set so as to indicate to adaptive logic module 210 that a strong (e.g., low latency, high bandwidth) network connection exists between client 301 and server 103, regardless of the condition of the actual network connection between such devices. Conversely where contextual information suggests to CLM 310 that a preference for low resolution content (e.g., a low resolution display, low battery life, user/device motion, etc.), it may cause the contextual network parameters to be set so as to indicate to adaptive logic module 210 that a weak (e.g., high latency, low bandwidth) network connection exists between client 101 and server 103, regardless of the condition of the actual network connection between such devices.

In either case, adaptive logic module 210 may execute in its traditional way, except insofar as it utilizes the contextual network parameters (instead of the parameters of the actual network connection between client 301 and server 103) to determine streaming parameters of a content stream that is to be provided by server 103. That is, adaptive logic module 210 may operate to determine contextual streaming parameters based at least in part on the contextual network parameters received from NWS 220.

More specifically, in some embodiments CLM 310 may transmit contextual network parameters to network stack 220 in a context control message (CCM). As mentioned above the context control message may be configured to cause network stack 220 to report the contextual network parameters to adaptive logic module 210, instead of the actual conditions of the network connection between client 301 and server 103. Such reporting may be triggered, for example, during the normal operation of adaptive logic module 210. That is, such reporting may be triggered in response to a query from adaptive logic module 210 to network stack 220, requesting a report of network conditions.

In response to receipt of the contextual network parameters, adaptive logic module 210 may analyze the contextual network parameters (and optionally the status of buffer 230), and determine whether an adjustment to the streaming parameters of a content stream provided (or to be provided) by server 103 is necessary. If so, adaptive logic module 210 may formulate and transmit a media request message to server 103. The media request message may include contextual streaming parameters, which may be understood to be streaming parameters that are determined by adaptive logic module 210 based at least in part on contextual network parameters, instead of the actual condition of the network connection between client 101 and server 103.

Using the above approach, CLM 310 may be leveraged to contextually adjust the behavior of an adaptive media player transparently, i.e., without modification of the adaptive logic of the media player. For example, CLM 310 may formulate contextual network parameters that affect the downstream determination of the bit-rate or other stream parameters by adaptive logic module 210, as generally described above.

It is noted that pursuant to its normal operation, MPM 206 may forward segments of content (i.e., of a received content stream) from buffer 230 to audiovisual pipeline 270 for processing and/or consumption by a user. In some instances, MPM 206 may instruct audiovisual pipeline 270 to process content of a received content stream in accordance with certain consumption parameters, which may be predetermined, e.g. by metadata in the content stream, by the manufacturer of media player module 206, etc. In response, audiovisual pipeline (or, more specifically, graphics stack 272, display stack 274, and/or audio stack (not shown) thereof) may process content of a received content stream in accordance with such consumption parameters.

With the foregoing in mind, in some embodiments CLM 310 may be configured to alter the manner in which content of a received content stream is processed by audiovisual pipeline 270, based at least in part on contextual information. In some embodiments, CLM 310 may accomplish this at least in part by transmitting a context control message (CCM) to audiovisual pipeline 270, as shown in FIG. 3. The context control message may include contextual consumption factors, which may be set or otherwise determined by CLM 310, taking into account relevant contextual factors, and optionally the capabilities of audiovisual pipeline 270. In any case, the context control message may be configured to cause audiovisual pipeline 270 to process the content in accordance with the contextual consumption parameters, which may supplement or override consumption parameters that may be specified by MPM 206 for the processing of a received content stream.

With the foregoing in mind, in some embodiments CLM 310 may be configured to determine contextual consumption parameters based at least in part on contextual information, e.g., received from sensor(s) 320. As may be appreciated, the contextual consumption parameters may differ from consumption parameters that may specified by MPM 206, and therefore may cause audiovisual pipeline 270 or components thereof to process a content stream in a manner that differs from the processing that would have been performed in response to the receipt of consumption parameters from MPM 206 alone. In this way, CLM 310 may be leveraged to contextually control the manner in which a content stream is processed for consumption by the audiovisual pipeline 270 of client 101.

To illustrate the foregoing concept, consider a scenario in which CLM 310 determines from contextual information that client device 301 is in a dimly or brightly lit environment when a content stream is initiated and/or received. In such instances CLM 310 may be configured to cause audiovisual pipeline 270 to process the content stream so as to adjust the brightness, contrast, and/or color of the content therein in a specified manner. CLM 310 may accomplish this, for example, by identifying appropriate contextual consumption parameters (e.g., brightness level, contrast level, etc.), and transmitting such parameters to audiovisual pipeline 270 (or an appropriate component thereof) in a context control message. The context control message may cause audiovisual pipeline 270 (or one or more components thereof) to perform one or more post-processing operations on the content of the received content stream. As may be appreciated, the post processing operations may be dictated or otherwise configured in accordance with the contextual consumption parameters.

Alternatively or additionally, CLM 310 may determine from contextual information that device 101 is in an environment containing relatively small or large amounts of ambient noise. Applying heuristics or another technique, CLM 310 may determine that an adjustment to the volume of the audio component of a received content stream may be desirable. To effect this adjustment, CLM 310 may generate contextual consumption parameters that include an audio adjustment and transmit such parameters to audiovisual pipeline 270 (or, more particularly, to an audio stack thereof) in a context control message. The context control message may be configured to cause audiovisual pipeline 270 (or, more particularly, the audio stack thereof) to adapt the volume of the content in accordance with the contextual consumption parameters.

Of course the foregoing examples merely illustrate specific non-limiting embodiments, and CLM 310 may be implemented to contextually adjust the reception and/or consumption of streaming content in a variety of ways. For example, CLM 310 may be implemented to contextually adjust the manner in which audiovisual pipeline 270 performs encoding/decoding/transcoding operations on the content of a content stream. Similarly CLM 310 may be implemented to affect video post processing of the content of a content stream and/or the manner in which a content stream is processed for display. In the latter case for example, CLM 310 may produce contextual consumption parameters that cause display stack 274 to perform display operations on the content of a content stream. Examples of such display operations include causing display stack 274 to render content for consumption on one or multiple screens, causing display stack to adjust the resolution of the content (e.g., to match or account for the resolution of a display) or a combination thereof.

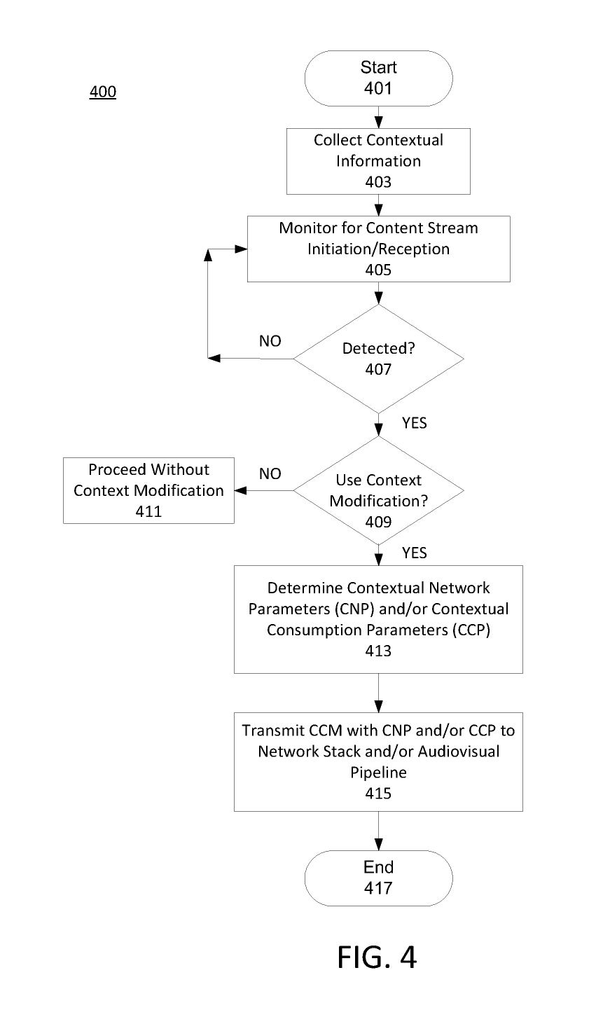

Another aspect of the present disclosure relates to methods for performing contextually aware content streaming. In this regard reference is made to FIG. 4, which is a flow chart of high level example operations of one example of a contextually aware content streamlining method consistent with the present disclosure, and which utilizes a context logic module as described above. As shown, method 400 begins at block 401. The method then proceeds to block 403, wherein contextual information may be collected. For example, in some embodiments contextual information may be obtained or otherwise derived by a context logic module, e.g., from data received from one or more sensors or from another source, as described above.

After or concurrently with the collection of contextual information the method may proceed to block 405, wherein the context logic module may monitor for the reception and/or initiation of a content stream. The context logic module may perform this operation, for example, by monitoring the status and parameters of the network connection between client 101 and server 103. Alternatively or additionally, detection and/or initiation of a content stream may be presumed by the context logic module upon the detection of the execution of a media player module, such as MPM 206.

In any case the method may proceed to block 407, wherein a determination may be made as to whether a content stream has been detected. If not, the method may loop back to block 405, wherein the context logic module may continue to monitor for the initiation and/or receipt of a content stream. Once initiation and/or reception of a content stream is detected however, the method may proceed to block 409.

Pursuant to block 409, the context logic module may make a determination as to whether context modification is to be applied. In this context, context modification refers to the contextual modification of stream parameters and/or consumption parameters, as generally described above. If context modification is not to be employed the method may proceed from block 409 to block 411, wherein content streaming may be performed without context modification (i.e., in accordance with the normal operation of a media player module).

If context modification is to be employed however, the method may proceed from block 409 to block 413. Pursuant to block 413, the context logic module may analyze contextual information collected pursuant to block 403, and determine contextual network parameters (CNP) and/or contextual consumption parameters (CCP), e.g., using heuristics, machine learning algorithms, or another technique as previously described. In some instances, the contextual network parameters and/or contextual consumption parameters may be set or otherwise determined to attain a desired user experience.

The method may then proceed to block 415, wherein the context logic module may transmit a context control message (CCM) to one or both of the network stack of a media player and the audiovisual pipeline of a client device, as generally described above. As previously described, the context control message may include contextual network parameters, contextual consumption parameters or a combination thereof. In instances where the CCM is transmitted to the network stack, it may be configured to cause the network stack to report the contextual network parameters to adaptive logic of the media player instead of actual network conditions, thereby affecting downstream determinations of the adaptive logic, as discussed above. In instances where the CCM is transmitted to the audiovisual pipeline of the client device, it may include contextual consumption parameters and may be configured to specify one or more graphics or display processing operations for performance on a content stream, as generally described above. At this point, the method may proceed to block 417 and end. Alternatively, the method may loop back to block 403, 405, or 407 and repeat until the content stream or the method is terminated.

To further explain the foregoing concepts reference is made to FIG. 5, which depicts one example of a messaging flow between various components of a contextually aware content streaming system consistent with one example embodiment. As shown, flow 500 begins at point 501, wherein a context logic module may collect contextual information, e.g., from one or more sensor(s) or another source. In this embodiment, at point 502 adaptive media player logic (e.g., adaptive logic module 210) or, more generally, a media player (e.g., MPM 206) of a client device (e.g., 301) may transmit a first content request message (CRM1) to a media server (e.g., server 103). Transmission of the first content request may be responsive, for example, to a user selection (e.g., via a graphical user interface) of content that is available for streaming on the media server.

CRM1 may include, for example, a content identifier and first streaming parameters, wherein the first streaming parameters inform the media server of the characteristics of the stream requested by the media player. The first streaming parameters may be set, for example, by the media player adaptive logic, and/or they may be default values specified by a manufacturer of the media player in question. Alternatively in instances wherein context modification may be applied before the initiation of a content stream, the first stream parameters may be determined by adaptive logic module based at least in part on contextual network conditions, as generally explained above and explained further below.

The media server may respond to CRM1 by initiating a content stream between it and the client device, as shown at point 503 of FIG. 5. As indicated in FIG. 5, the content stream at this point may be in accordance with the first stream parameters specified in CRM1.

At point 504, the context logic module may detect the content stream provided the media server and determine contextual network parameters (CNP) based at least in part on the contextual information obtained pursuant to point 501. The manner in which the CNP may be determined by the context logic module has been previously described and is therefore not reiterated.

At point 505 the context logic module may transmit a context control message (CCM) including the contextual network parameters (CNP) to the network stack of the adaptive media player on the client device. As described above, the CCM may be configured to cause the network stack of the adaptive media player to report the contextual network parameters to the media player adaptive logic. This concept is illustrated by points 506 and 507, which illustrate that media player adaptive logic may query the network stack for network parameters/conditions and, in response, the network stack may report the contextual network parameters provided in the context control message.

At point 508, the media player adaptive logic may evaluate the contextual network parameters (instead of actual network conditions) and optionally the status of a buffer, and make a determination as to whether an adjustment to the stream parameters of the content stream provided by the media server is desired. In this example an adjustment is desired, and so point 508 depicts a scenario in which the media player adaptive logic causes the transmission of a second content request message (CRM2) to the media server. Consistent with the foregoing discussion, CRM2 may include contextual stream parameters that were derived by the operation of media player adaptive logic on the contextual network parameters, instead of the parameters of the actual network connection between the client and the media server.

As shown at point 509, media server may adjust the stream parameters of the content stream such that they are in accordance with the contextual stream parameters received in CRM2. By way of example, the contextual stream parameters may cause media server to alter the quality (e.g., bit rate) of the content stream in response to CRM2, such that the quality of the stream is different from that quality of the stream provided in response to CRM1.

It is noted that FIG. 5 illustrates one example of a messaging flow in which a context control message is provided to the network stack of a media player module after the initiation of a content stream. It should be understood that this example is not limiting, and that context control messages consistent with the present disclosure may be transmitted to the network stack at any time, including before the initiation of a content stream from a media server.

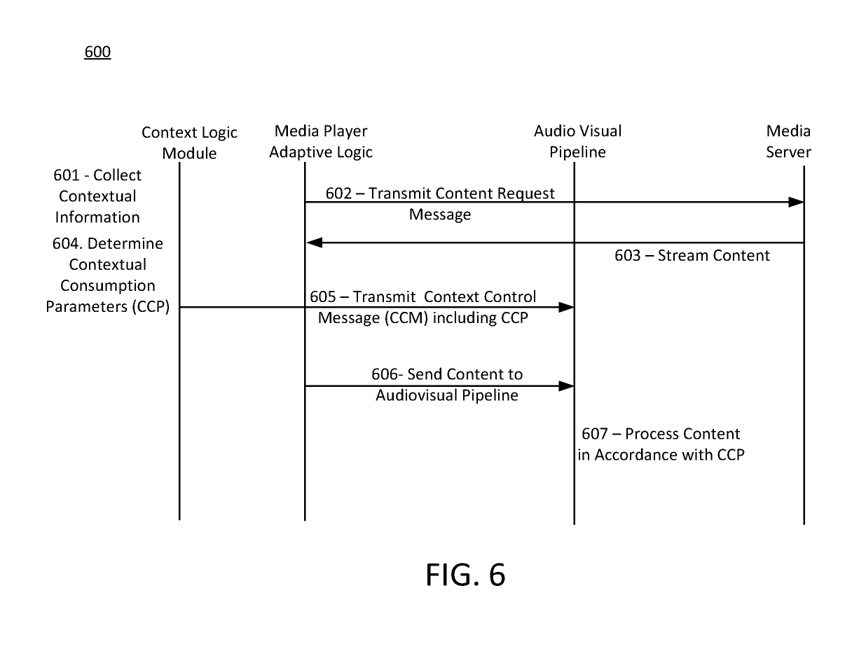

Reference is now made to FIG. 6, which depicts one example of a messaging flow between various components of another contextually aware content streaming system consistent with another example embodiment. As shown, flow 600 begins at point 601, wherein a context logic module may collect contextual information, e.g., from one or more sensor(s) or another source. In this embodiment, at point 602 adaptive media player logic (e.g., adaptive logic module 210) or, more generally, a media player (e.g., MPM 206) of a client device (e.g., 301) may transmit a content request message to a media server (e.g., server 103). Transmission of the content request may be responsive, for example, to a user selection (e.g., via a graphical user interface) of content that is available for streaming on the media server. As shown at point 603, media server may respond to the content request message by transmitting a content stream to client 101 or, more specifically, to a media player module (or adaptive logic) thereof.

At point 604, the context logic module may detect the initiation and/or reception of a content stream from the media server and determine contextual consumption parameters (CCP) based at least in part on the contextual information obtained pursuant to point 601. The manner in which the CCP may be determined by the context logic module has been previously described and is therefore not reiterated.

At point 605 the context logic module may transmit a context control message (CCM) including the contextual consumption parameters (CNP) to the audiovisual pipeline (or component thereof) of the client device. As described above, the CCM may be configured to configure the audiovisual pipeline (or a component thereof) to process content in the received content stream in accordance with the contextual consumption parameters specified therein. This concept is illustrated by points 606 and 607, wherein it is illustrated that the media player module (or, more specifically, the adaptive logic thereof) may cause content of the content stream to be transmitted to the audiovisual pipeline of the client, after which the audiovisual pipeline (or a component thereof) may process the content in accordance with the contextual consumption parameters.

### EXAMPLES

The following examples enumerate additional example embodiments consistent with the present disclosure.

### Example 1

According to this example there is provided a contextually aware media streaming system, including: a client device including a processor, a memory, a media player module, a context logic module, and one or more sensors, the media player module including adaptive logic and a network stack, wherein: the context logic module is to collect contextual information at least in part from the one or more sensors, to determine contextual network parameters based at least in part on the contextual information, and to cause the transmission of a first context control message to the network stack; the first context control message is to cause the network stack to report the contextual network parameters to the adaptive logic; and in response to receipt of the contextual network parameters, the adaptive logic determines contextual streaming parameters for a content stream to be provided from a server based at least in part on the contextual network parameters.

### Example 2

This example includes any or all of the features of example 1, wherein the first context control message causes the network stack to report the contextual network factors to the adaptive logic, instead of parameters of an actual network connection between the client device and the server.

### Example 3

This example includes any or all of the features of example 1, wherein in response to receipt of the contextual network parameters, the adaptive logic further causes the client device to transmit a media request message including the contextual streaming parameters to the server, the media request message configured to cause the server to transmit the content stream in accordance with the contextual streaming parameters to the client.

### Example 4

This example includes any or all of the features of any one of examples 1 to 4, wherein the contextual streaming parameters specify a bit-rate for content in the content stream.

### Example 5

This example includes any or all of the features of any one of examples 1 to 5, wherein the contextual information includes at least one of an identity of a user, user preferences, a location of the client device, motion of the client device, biometric information, ambient noise, ambient light, workload of the processor, a battery level of the client device, a display type of the client device, a resolution of a display of the client device, or a resolution of an external display.

### Example 6

This example includes any or all of the features of any one of examples 1 to 6, wherein the at least one sensor includes one or more physical sensors, virtual sensors, or a combination thereof.

### Example 7

This example includes any or all of the features of example 6, wherein the at least one sensor includes one or more physical sensors selected from the group consisting of a camera, a position sensor, a light sensor, a microphone, a biometric scanner, a motion sensor, and combinations thereof.

### Example 8

This example includes any or all of the features of example 6, wherein the at least one sensor includes one or more virtual sensors selected from the group consisting of a battery level sensor, a network status sensor, a processor workload sensor, and combinations thereof.

### Example 9

This example includes any or all of the features of any one of examples 1 to 8, wherein: in response to detection of a content stream having first streaming parameters from the server, the context logic module is to cause the transmission of the first context control signal to the network stack, so as to cause the network stack to report the contextual network parameters to the adaptive logic; and the media request message is configured to cause the server to transmit the content stream in accordance with the contextual streaming parameters to the client.

### Example 10

This example includes any or all of the features of example 9, wherein a bit-rate of content in the content stream having the first streaming parameters differs from a bit-rate of content in the content stream that is transmitted in accordance with the contextual streaming parameters.

### Example 11

This example includes any or all of the features of any one of examples 1 to 10, wherein the media player module further includes a buffer, and the adaptive logic is to determine the contextual streaming parameters based at least in part on the contextual network parameters and a buffer level of the buffer.

### Example 12

This example includes any or all of the features of example 11, wherein the contextual streaming parameters comprise a bit-rate of content in the content stream, and the adaptive logic is to adjust the bit-rate based at least in part on the contextual network parameters and the buffer level.

### Example 13

This example includes any or all of the features of example 12, wherein: when the adaptive logic is further to determine whether the buffer level will remain full or whether the buffer will starve based at least in part on the contextual network parameters, the contextual streaming parameters are configured to cause the server to transmit relatively low bit-rate content in the content stream; and when the adaptive logic determines that the buffer may remain full based at least in part on the contextual network parameters, the contextual streaming parameters are configured to cause the server to transmit relatively high bit-rate content in the content stream.

### Example 14

This example includes any or all of the features of any one of examples 1 to 13, further including an audiovisual pipeline to process a received content stream for consumption wherein: the context logic module is further to determine contextual consumption parameters based at least in part on the contextual information, and to cause the transmission of a second context control message to the audiovisual pipeline; and in response to receipt of the second context control message, the audiovisual pipeline is to process content of the received content stream in accordance with the contextual consumption parameters.

### Example 15

This example includes any or all of the features of example 14, wherein the audiovisual pipeline includes a graphics stack, and the contextual consumption parameters are configured to cause the graphics stack to perform a post processing operation on the content of the received content stream.

### Example 16

This example includes any or all of the features of example 15, wherein the post processing operation includes at least one of a brightness adjustment operation, a contrast adjustment operation, and a color enhancement operation.

### Example 17

This example includes any or all of the features of example 15, wherein the contextual consumption parameters are configured to cause the audiovisual pipeline to perform at least one of a decoding operation, encoding operation, or a transcoding operation on the content of the received content stream.

### Example 18

This example includes any or all of the features of example 14, wherein the audiovisual pipeline includes a display stack, and the contextual consumption parameters are configured to cause the display stack to perform at least one of a rendering operation and a scaling operation on the content of the received content stream.

### Example 19

This example includes any or all of the features of example 14, wherein: the media player module is to provide content of the received content stream to the audiovisual pipeline for processing in accordance with first consumption parameters; and the contextual consumption parameters are different from the first consumption parameters.

### Example 20

According to this example there is provided a method for performing contextually aware media streaming, including: determining contextual network parameters at least in part from contextual information of at least one sensor of a client device; and determining contextual streaming parameters for a content stream based at least in part on the contextual network parameters, the content stream to be provided from a server to the client device.

### Example 21

This example includes any or all of the features of example 20, wherein the method further includes transmitting a first context control message to a network stack of a media player on the client device, wherein: the first context control message causes the network stack to report the contextual network parameters to adaptive logic of the media player so as to cause the adaptive logic to determine the contextual streaming parameters.

### Example 22

This example includes any or all of the features of any one of examples 20 and 21, wherein the contextual network parameters are the same or different from parameters of an actual network connection between the client device and the server.

### Example 23

This example includes any or all of the features of any one of examples 20 to 22 wherein the contextual network parameters differ from the parameters of an actual network connection.

### Example 24

This example includes any or all of the features of example 21, further including transmitting a media request message to the server, the media request message configured to cause the server to transmit a content stream in accordance with the contextual streaming parameters.

### Example 25

This example includes any or all of the features of any one of examples 20 to 24, wherein the contextual streaming parameters specify a bit-rate for content in the content stream.

### Example 26

This example includes any or all of the features of any one of examples 20 to 25, wherein the contextual information includes at least one of an identity of a user, user preferences, a location of the client device, motion of the client device, biometric information, ambient noise, ambient light, workload of the processor, a battery level of the client device, a display type of the client device, a resolution of a display of the client device, or a resolution of an external display.

### Example 27

This example includes any or all of the features of examples 20 to 26, wherein the at least one sensor includes one or more physical sensors, virtual sensors, or a combination thereof.

### Example 28

This example includes any or all of the features of any one of examples 20 to 27, wherein the at least one sensor includes one or more physical sensors selected from the group consisting of a camera, a position sensor, a light sensor, a microphone, a biometric scanner, a motion sensor, and combinations thereof.

### Example 29

This example includes any or all of the features of any one of examples 20 to 28, wherein the at least one sensor includes one or more virtual sensors selected from the group consisting of a battery level sensor, a network status sensor, a processor workload sensor, and combinations thereof.

### Example 30

This example includes any or all of the features of example 21, wherein: the first context control message is transmitted in response to the reception of a content stream having first streaming parameters from the server.

### Example 31

This example includes any or all of the features of example 30, wherein a bit-rate of content in the content stream having the first streaming parameters differs from a bit-rate of content in the content stream in accordance with the contextual streaming parameters.

### Example 32

This example includes any or all of the features of example 21, wherein the media player includes a buffer, and determining the contextual streaming parameters is based on at least in part on the contextual network parameters and a buffer level of the buffer.

### Example 33

This example includes any or all of the features of example 32, wherein the contextual streaming parameters comprise a bit-rate of content in the content stream, and the method further includes adjusting the bit-rate based at least in part on the contextual network parameters and the buffer level.

### Example 34

This example includes any or all of the features of example 33, wherein the method further includes: determining whether the buffer level will remain full or whether the buffer will starve based at least in part on the contextual network parameters; when it is determined that the buffer will starve, the method further includes configuring the contextual streaming parameters to cause the server to transmit the relatively low bit-rate content in the content stream; and when it is determined that the buffer level will remain full, the method further includes configuring the contextual streaming parameters to cause the server to transmit relatively high bit-rate content in the content stream.

### Example 35

This example includes any or all of the features of any one of examples 20 to 34, wherein the client device further includes an audiovisual pipeline to process a received content stream for consumption, and the method further includes: determining contextual consumption parameters based at least in part on the contextual information; and causing the audiovisual pipeline to process the received content stream in accordance with the contextual consumption parameters.

### Example 36

This example includes any or all of the features of example 35, wherein causing the audiovisual pipeline to process the received content stream in accordance with the contextual consumption parameters includes: transmitting a second context control message to the audiovisual pipeline, wherein the second context control message is configured to cause the audiovisual pipeline to process the received content stream in accordance with the contextual consumption parameters.

### Example 37

This example includes any or all of the features of example 36, wherein the audiovisual pipeline includes a graphics stack, and the contextual consumption parameters are configured to cause the graphics stack to perform a post processing operation on the content of the received content stream.

### Example 38

This example includes any or all of the features of example 37, wherein the post processing operation includes at least one of a brightness adjustment operation, a contrast adjustment operation, and a color enhancement operation.

### Example 39

This example includes any or all of the features of example 37, wherein the contextual consumption parameters are configured to cause the graphics stack to perform at least one of a decoding operation, encoding operation, or a transcoding operation on the content of the received content stream.

### Example 40

This example includes any or all of the features of example 36, wherein the audiovisual pipeline includes a display stack, and the contextual consumption parameters are configured to cause the display stack to perform at least one of a rendering operation and a scaling operation on the content of the received content stream.

### Example 41

This example includes any or all of the features of example 37, wherein: the client device further includes a media player to provide content of the received content stream to the audiovisual pipeline for processing in accordance with first consumption parameters; and the contextual consumption parameters are different from the first consumption parameters.

### Example 42

According to this example there is provided at least one computer readable medium including instructions for performing contextually aware media streaming, wherein the instructions when executed by a processor of a client device cause the client device to perform the following operations including: determining contextual network parameters at least in part from contextual information of at least one sensor of a client device; and determining contextual streaming parameters for a content stream based at least in part on the contextual network parameters, the content stream to be provided from a server to the client device.

### Example 43

This example includes any or all of the features of example 42, wherein the instructions when executed further cause the client device to perform the following operations including: transmitting a first context control message to a network stack of a media player on the client device, wherein the first context control message causes the network stack to report the contextual network parameters to adaptive logic of the media player so as to cause the adaptive logic to determine the contextual streaming parameters.

### Example 44

This example includes any or all of the features of any one of examples 42 and 43, wherein the contextual network parameters are the same or different from parameters of an actual network connection between the client device and the server.

### Example 45

This example includes any or all of the features of example 44, wherein the contextual network parameters differ from the parameters of an actual network connection.

### Example 46

This example includes any or all of the features of examples 42 to 45, wherein the instructions when executed further cause the client device to perform the following operations including: transmitting a media request message to the server, the media request message configured to cause the server to transmit a content stream in accordance with the contextual streaming parameters.

### Example 47

This example includes any or all of the features of any one of examples 42 to 46, wherein the contextual streaming parameters specify a bit-rate for content in the content stream.

### Example 48

This example includes any or all of the features of any one of examples 42 to 47, wherein the contextual information includes at least one of an identity of a user, user preferences, a location of the client device, motion of the client device, biometric information, ambient noise, ambient light, workload of the processor, a battery level of the client device, a display type of the client device, a resolution of a display of the client device, or a resolution of an external display.

### Example 49

This example includes any or all of the features of any one of examples 42 to 48, wherein the at least one sensor includes one or more physical sensors, virtual sensors, or a combination thereof.

### Example 50

This example includes any or all of the features of example 49, wherein the at least one sensor includes one or more physical sensors selected from the group consisting of a camera, a position sensor, a light sensor, a microphone, a biometric scanner, a motion sensor, and combinations thereof.

### Example 51

This example includes any or all of the features of example 49, wherein the at least one sensor includes one or more virtual sensors selected from the group consisting of a battery level sensor, a network status sensor, a processor workload sensor, and combinations thereof.

### Example 52

This example includes any or all of the features of example 43, wherein: the first context control message is transmitted in response to the reception of a content stream having first streaming parameters from the server.

### Example 53

This example includes any or all of the features of example 52, wherein a bit-rate of content in the content stream having the first streaming parameters differs from a bit-rate of content in the content stream in accordance with the contextual streaming parameters.

### Example 54

This example includes any or all of the features of 43, wherein the media player includes a buffer, and the instructions when executed further cause the client device to perform the following operations including: determining the contextual streaming parameters based on at least in part on the contextual network parameters and a buffer level of the buffer.

### Example 55

This example includes any or all of the features of example 54, wherein the contextual streaming parameters comprise a bit-rate of content in the content stream, and the instructions when executed further cause the client device to perform the following operations including: adjusting the bit-rate based at least in part on the contextual network parameters and the buffer level.

### Example 56

This example includes any or all of the features of any one of examples 54 and 55, wherein the instructions when executed further cause the client device to perform the following operations including: determining whether the buffer level will remain full or whether the buffer will starve based at least in part on the contextual network parameters; configuring, when it is determined that the buffer will starve, the contextual streaming parameters to cause the server to transmit the relatively low bit-rate content in the content stream; and configuring, when it is determined that the buffer level will remain full, the contextual streaming parameters to cause the server to transmit relatively high bit-rate content in the content stream.

### Example 57

This example includes any or all of the features of any one of examples 42 to 56, wherein the client device further includes an audiovisual pipeline to process a received content stream for consumption, and the instructions when executed further cause the client device to perform the following operations including: determining contextual consumption parameters based at least in part on the contextual information; and causing the audiovisual pipeline to process the received content stream in accordance with the contextual consumption parameters.

### Example 58

This example includes any or all of the features of example 57, wherein causing the audiovisual pipeline to process the received content stream in accordance with the contextual consumption parameters includes: transmitting a second context control message to the audiovisual pipeline, wherein the second context control message is configured to cause the audiovisual pipeline to process the received content stream in accordance with the contextual consumption parameters.

### Example 59

This example includes any or all of the features of example 58, wherein the audiovisual pipeline includes a graphics stack, and the contextual consumption parameters are configured to cause the graphics stack to perform a post processing operation on the content of the received content stream.

### Example 60

This example includes any or all of the features of example 59, wherein the post processing operation includes at least one of a brightness adjustment operation, a contrast adjustment operation, and a color enhancement operation.

### Example 61

This example includes any or all of the features of example 59, wherein the contextual consumption parameters are configured to cause the graphics stack to perform at least one of a decoding operation, encoding operation, or a transcoding operation on the content of the received content stream.

### Example 62

This example includes any or all of the features of example 58, wherein the audiovisual pipeline includes a display stack, and the contextual consumption parameters are configured to cause the display stack to perform at least one of a rendering operation and a scaling operation on the content of the received content stream.

### Example 63

This example includes any or all of the features of example 59, wherein: the client device further includes a media player to provide content of the received content stream to the audiovisual pipeline for processing in accordance with first consumption parameters; and the contextual consumption parameters are different from the first consumption parameters.

### Example 64

According to this example there is provided at least one computer readable medium including instructions which when executed by a processor of a client device cause the client device to perform the method of any one of examples 20 to 41

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. A contextually aware media streaming system, comprising:
a client device comprising a processor, a memory, a media player module, a context logic module, and one or more sensors, the media player module comprising adaptive logic and a network stack, wherein:
the context logic module is to collect contextual information at least in part from said one or more sensors, to determine contextual network parameters based at least in part on said contextual information, and to cause the transmission of a first context control message to said network stack;
said first context control message is to cause said network stack to report said contextual network parameters to said adaptive logic; and
in response to receipt of said contextual network parameters, said adaptive logic determines contextual streaming parameters for a content stream to be provided from a server based at least in part on said contextual network parameters.

2. The contextually aware media streaming system of claim 1, wherein said first context control message causes said network stack to report said contextual network factors to said adaptive logic, instead of parameters of an actual network connection between said client device and said server.

3. The contextually aware media streaming system of claim 1, wherein in response to receipt of said contextual network parameters, said adaptive logic further causes the client device to transmit a media request message comprising said contextual streaming parameters to said server, said media request message configured to cause said server to transmit said content stream in accordance with said contextual streaming parameters to said client.

4. The contextually aware media streaming system of claim 1, wherein said at least one sensor comprises one or more physical sensors, virtual sensors, or a combination thereof, wherein:
said physical sensors are selected from the group consisting of a camera, a position sensor, a light sensor, a microphone, a biometric scanner, a motion sensor, and combinations thereof; and
said virtual sensors are selected from the group consisting of a battery level sensor, a network status sensor, a processor workload sensor, and combinations thereof.

5. The contextually aware media streaming system of claim 1, wherein:
in response to detection of a content stream having first streaming parameters from said server, said context logic module is to cause the transmission of said first context control signal to said network stack, so as to cause said network stack to report said contextual network parameters to said adaptive logic; and
said media request message is configured to cause said server to transmit said content stream in accordance with said contextual streaming parameters to said client.

6. The contextually aware media streaming system of claim 1, wherein said media player module further comprises a buffer, and said adaptive logic is to determine said contextual streaming parameters based at least in part on said contextual network parameters and a buffer level of said buffer.

7. The contextually aware media streaming system of claim 1, further comprising an audiovisual pipeline to process a received content stream for consumption wherein:
said context logic module is further to determine contextual consumption parameters based at least in part on said contextual information, and to cause the transmission of a second context control message to said audiovisual pipeline; and
in response to receipt of said second context control message, said audiovisual pipeline is to process content of said received content stream in accordance with said contextual consumption parameters.

8. The contextually aware media streaming system of claim 7, wherein said audiovisual pipeline comprises a graphics stack, and said contextual consumption parameters are configured to cause said graphics stack to perform a post processing operation on said content of said received content stream.

9. The contextually aware streamlining media system of claim 8, wherein:
said media player module is to provide content of said received content stream to said audiovisual pipeline for processing in accordance with first consumption parameters; and
said contextual consumption parameters are different from said first consumption parameters.

10. A method for performing contextually aware media streaming, comprising:
determining contextual network parameters at least in part from contextual information of at least one sensor of a client device; and
determining contextual streaming parameters for a content stream based at least in part on said contextual network parameters, said content stream to be provided from a server to said client device.

11. The method of claim 10, further comprising transmitting a first context control message to a network stack of a media player on said client device, wherein:
said first context control message causes said network stack to report said contextual network parameters to adaptive logic of said media player, so as to cause said adaptive logic to determine said contextual streaming parameters; and
said contextual network parameters are different from parameters of an actual network connection between said client device and said server.

12. The method of claim 10, further comprising transmitting a media request message to said server, said media request message configured to cause said server to transmit a content stream in accordance with said contextual streaming parameters.

13. The method of claim 10, wherein:
said at least one sensor comprises one or more physical sensors, virtual sensors, or a combination thereof;
said physical sensors are selected from the group consisting of a camera, a position sensor, a light sensor, a microphone, a biometric scanner, a motion sensor, and combinations thereof; and
said virtual sensors are selected from the group consisting of a battery level sensor, a network status sensor, a processor workload sensor, and combinations thereof.

14. The method of claim 13, wherein:
said first context control message is transmitted in response to the reception of a content stream having first streaming parameters from said server; and
a bit-rate of content in said content stream having said first streaming parameters differs from a bit-rate of content in said content stream in accordance with said contextual streaming parameters.

15. The method of claim 10, wherein said media player comprises a buffer, and determining said contextual streaming parameters is based on at least in part on said contextual network parameters and a buffer level of said buffer.

16. The method of claim 11, wherein said client device further comprises an audiovisual pipeline to process a received content stream for consumption, and the method further comprises:
determining contextual consumption parameters based at least in part on said contextual information; and
causing said audiovisual pipeline to process said received content stream in accordance with said contextual consumption parameters.

17. The method of claim 16, wherein:
said media player is to provide content of said received content stream to said audiovisual pipeline for processing in accordance with first consumption parameters; and
causing said audiovisual pipeline to process said received content stream in accordance with said contextual consumption parameters comprises:
transmitting a second context control message to said audiovisual pipeline, wherein the second context control message is configured to cause said audiovisual pipeline to process said received content stream in accordance with said contextual consumption parameters, said contextual consumption parameters being different from said first consumption parameters.

18. At least one computer readable medium comprising instructions for performing contextually aware media streaming, wherein said instructions when executed by a processor of a client device cause the client device to perform the following operations comprising:
determining contextual network parameters at least in part from contextual information of at least one sensor of a client device; and
determining contextual streaming parameters for a content stream based at least in part on said contextual network parameters, said content stream to be provided from a server to said client device.

19. The at least one computer readable medium of claim 18, wherein said instructions when executed further cause the client device to perform the following operations comprising:
transmitting a first context control message to a network stack of a media player on said client device, wherein said first context control message causes said network stack to report said contextual network parameters to adaptive logic of said media player; and
using said adaptive logic to determine said contextual streaming parameters;
wherein said contextual network parameters are different from parameters of an actual network connection between said client device and said server.

20. The at least one computer readable medium of claim 18, wherein said instructions when executed further cause the client device to perform the following operations comprising:
transmitting a media request message to said server, said media request message configured to cause said server to transmit a content stream in accordance with said contextual streaming parameters.

21. The at least one computer readable medium of claim 18, wherein:
said at least one sensor comprises one or more physical sensors, virtual sensors, or a combination thereof;
said physical sensors are selected from the group consisting of a camera, a position sensor, a light sensor, a microphone, a biometric scanner, a motion sensor, and combinations thereof; and
said virtual sensors are selected from the group consisting of a battery level sensor, a network status sensor, a processor workload sensor, and combinations thereof.

22. The at least one computer readable medium of claim 19, wherein:
said first context control message is transmitted in response to the reception of a content stream having first streaming parameters from said server; and
a bit-rate of content in said content stream having said first streaming parameters differs from a bit-rate of content in said content stream in accordance with said contextual streaming parameters.

23. The at least one computer readable medium of claim 19, wherein said media player comprises a buffer, and said instructions when executed further cause said client device to perform the following operations comprising:
determining said contextual streaming parameters based on at least in part on said contextual network parameters and a buffer level of said buffer.

24. The at least one computer readable medium of claim 19, wherein said client device further comprises an audiovisual pipeline to process a received content stream for consumption, and said instructions when executed further cause said client device to perform the following operations comprising:
determining contextual consumption parameters based at least in part on said contextual information; and
causing said audiovisual pipeline to process said received content stream in accordance with said contextual consumption parameters.

25. The at least one computer readable medium of claim 24, wherein said media player is to provide a content stream to said audiovisual pipeline for processing in accordance with first consumption parameters, wherein causing said audiovisual pipeline to process said received content stream in accordance with said contextual consumption parameters comprises:
transmitting a second context control message to said audiovisual pipeline, wherein the second context control message is configured to cause said audiovisual pipeline to process said received content stream in accordance with said contextual consumption parameters.
